(19) United States
(12) Patent Application Publication
(10) Pub. No.: US 2015/0077226 A1
(43) Pub. Date: Mar. 19, 2015

(54) METHOD AND APPARATUS FOR CONSERVING ENERGY IN RKE AND TPM VEHICLE SYSTEMS

(71) Applicant: Xing Ping Lin, Orchard Lake, MI (US)

(72) Inventor: Xing Ping Lin, Orchard Lake, MI (US)

(21) Appl. No.: 14/474,521

(22) Filed: Sep. 2, 2014

Related U.S. Application Data
(60) Provisional application No. 61/878,154, filed on Sep. 16, 2013.

(51) Int. Cl. H04W 52/02; G07C 9/00

(52) U.S. Cl. CPC H04W 52/0225; G07C 9/00182; G07C 2009/00261
USPC 340/5.72

(57) ABSTRACT

A method and apparatus for controlling a vehicle based transmitter/receiver system including transmitting a first signal portion at a first baud rate and second signal portion at a second baud rate where the first baud rate is faster than the second baud rate, the first signal portion including a wake-up portion, and controlling the receiver to periodically wake up to receive the first signal portion and stay awake to receive the second signal portion only if the wake-up portion of the received signal is valid.

### CROSS REFERENCE TO RELATED APPLICATIONS

This patent application claims priority to and the benefit of co-pending U.S. Provisional Application Ser. No. 61/878,154, filed Sep. 16, 2013, entitled METHOD AND APPARATUS FOR CONSERVING ENERGY IN RKE AND TPM VEHICLE SYSTEMS, which is incorporated herein by reference in its entirety.

### FIELD OF THE INVENTION

The present invention is directed to a method and apparatus for conserving energy in remote keyless entry (“RKE”) and tire pressure monitoring (“TPM”) systems in vehicles.

### BACKGROUND

A vehicle RKE system includes an RKE module in the vehicle (‘vehicle-based receiver’) and a portable RF transmitter (‘fob’) that is carried by the vehicle owner. When the fob transmits its RF signal to vehicle-based receiver, the receiver detects the RE transmission. The RF signal transmitted from the fob includes a wake-up portion and a data portion. The data portion includes an identification (ID) portion uniquely identifying that fob, as well as a command portion that is a specific request for the vehicle to perform a function such as the unlocking of the vehicle doors. If the vehicle-based receiver determines that the received ID portion of the signal matches the fob associated with that vehicle, then the receiver will send a command to the vehicle bus to ask for the associated response (e.g., unlock door).

The vehicle-based receiver is powered from the vehicle battery. To reduce average current draw on the vehicle battery, the receiver is programmed to function in a periodic ON/OFF polling mode. The vehicle-based receiver is asleep, expending very little or no energy, when in the OFF mode, and is awake and active (and thereby expending energy) when in the ON mode. The receiver periodically awakens to the ON mode for a short period of time to listen for any RF transmission from a fob. If an RF signal is received and that signal meets certain wake-up criteria, then the vehicle-based receiver will stop polling and instead stay awake to decode the rest of the data transmitted from the fob. If no valid RF signal is received, however, the vehicle-based receiver will return to the OFF mode and sleep. The vehicle-based receiver is therefore able to maintain a low average quiescent current draw and still respond to transmissions from the remote fob.

Receivers employed in TPM systems utilize similar polling schemes. Indeed, often the same vehicle receiver is used for receiving transmissions from both RKE fobs and tire-mounted TPM sensors.

The Federal Communications Commission (“FCC”) has established power limit regulations regarding all manner of RF transmissions, including those arising from both RKE and TPM vehicle systems. To determine compliance with these regulations, the average radiated power of a transmitter is measured over a 100 ms time interval, where that interval is chosen to include the interval during which transmitter power is at its highest level. The RF transmissions both from an RKE fob and from a TPM sensor typically last for much less than 100 ms. Thus, the measurement equates to an averaging of the power transmitted by an RKE fob or TPM sensor over a 100 ms time interval that is selected to include the active transmission interval of the transmitter (which, again, is less than 100 ms in duration). The transmitter power is averaged by a factor that may be defined as:

Average factor=(total active transmission time)/100 ms

The shorter the transmitter active time, the better the average factor and the more power that may be transmitted during that active time while still complying with FCC regulations.

### SUMMARY OF THE INVENTION

The present invention combines fast and slow data transmissions to reduce the vehicle-based receiver average quiescent current while still maintaining high signal recognition for data portions of the signal. This ‘fast and slow’ method will also reduce the energy consumption in the transmitting device (fob or TPM sensor), in those systems where the current draw of the vehicle-based receiver is already satisfactory.

In accordance with one example embodiment, a vehicle-based transmitter/receiver system is provided. The system comprises a transmitter unit including a transmitter and an associated transmitter controller. The transmitter controller controls the transmitter to transmit a first signal portion at a first baud rate and second signal portion at a second baud rate where the first baud rate is faster than the second baud rate, and where the first signal portion includes a wake-up portion. The system further comprises a receiver unit adapted to receive the first signal portion at the first baud rate and the second signal portion at the second baud rate. The receiver unit periodically wakes up to listen for the first signal portion and only stays awake to receive the second signal portion if a valid wake-up portion is received.

In accordance with another example embodiment, a method is provided for controlling a vehicle-based transmitter/receiver system. The method includes the step of transmitting, at one location, a first signal portion at a first baud rate and second signal portion at a second baud rate, where the first baud rate is faster than the second baud rate and the first signal portion includes a wake-up portion. The method further includes the step of receiving, at a second location, the first and second signal portions. The receiving step includes the steps of sleeping to conserve energy, periodically waking up to listen for the wake-up portion of the signal transmitted from the one location, and staying awake to receive the second signal portion only if a valid wake-up portion is heard. The step of periodically waking up includes the step of selecting the duration of the awake interval to be relatively short in view of the fast rate of the first baud rate.

In accordance with yet another example embodiment, a radio frequency transmitter is provided for communicating digital information to a land-based motor vehicle. The transmitter sends a wake-up portion followed by a data portion, where the baud rate of the wake-up portion is faster than the baud rate of the data portion.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a vehicle RKE system;

FIG. 2 is a chart that illustrates the sensitivity profile of a receiver and depicts the manner in which bit error rate varies with signal-to-noise (E/N0) ratio;

FIG. 3 depicts the polling of a vehicle-based receiver and a fob signal having a traditional format, where the same bit rate is employed for the wake-up and data portions of the signal; and,

FIG. 4 depicts the palling of a vehicle-based receiver and a fob signal having a wake-up portion with a faster bit rate and a data portion with a slower bit rate.

### DETAILED DESCRIPTION

In the example embodiments described hereinafter, one bit is transmitted in each signaling (or baud) interval, hence the bit rate, data rate, and baud rate are all the same. This ‘one bit per signaling interval’ format is common for conventional RKE and TPM signaling systems. In other, different example embodiments multiple bits could be transmitted in each signaling interval. In such example embodiments, the baud rate will be different than (a fraction of) the bit rate and data rate.

Referring to FIG. 1, a block diagram is provided that depicts an RKE system 10 for a land-based motor vehicle, such as a car, truck, or the like. The system 10 has a fob 12 and a vehicle-based receiver 14. The vehicle-based receiver, which is sometimes referred to in the industry as an RKE module, is powered by the vehicle battery 16 and includes an RF receiver 18 and an RKE controller 20. Controller 20 processes the received signal and communicates with the rest of the vehicle via a bus 22. In response to command signals received from a fob associated with the vehicle (i.e., a fob that transmits an RF signal with a valid ID portion, such as fob 12 of FIG. 1), the controller 20 outputs a command to the vehicle bus 22 to control functions of controlled devices 24, such as the unlocking of one or more doors of the vehicle. The control function is often accomplished via an intermediate electronic control unit (not shown) that is sometimes referred to as a ‘body control module’.

The present invention is also applicable to other transmit/receive vehicle systems, such as TPM systems. In TPM systems, the transmitter and controller take the form of a tire pressure monitoring sensor installed within a vehicle tire. The transmitter (sensor) will collect tire data, such as air pressure and tire temperature, and will encode the data in the data portion of the signal to be transmitted.

In the design of any wireless digital communication system, two factors that are considered and managed are signal-to-noise ratio and bit error. Signal-to-noise (“S/N”) ratio may be defined as the ratio of energy per binary symbol (Eb, or, here, energy per binary bit) to noise density (NO):

$$\frac{Eb}{N 0} = \frac{S}{N 0} ( \frac{1}{R} ) \qquad ( 1 )$$

Where S is the average signal power and R is the bit rate.

A higher S/N ratio gives a receiver a better chance to recover, without error, the data embedded in the signal. The faster the data rate “R” is, however, the worse the S/N ratio becomes. The receiver sensitivity is defined to be the S/N ratio required for that receiver to meet a certain bit error criterion.

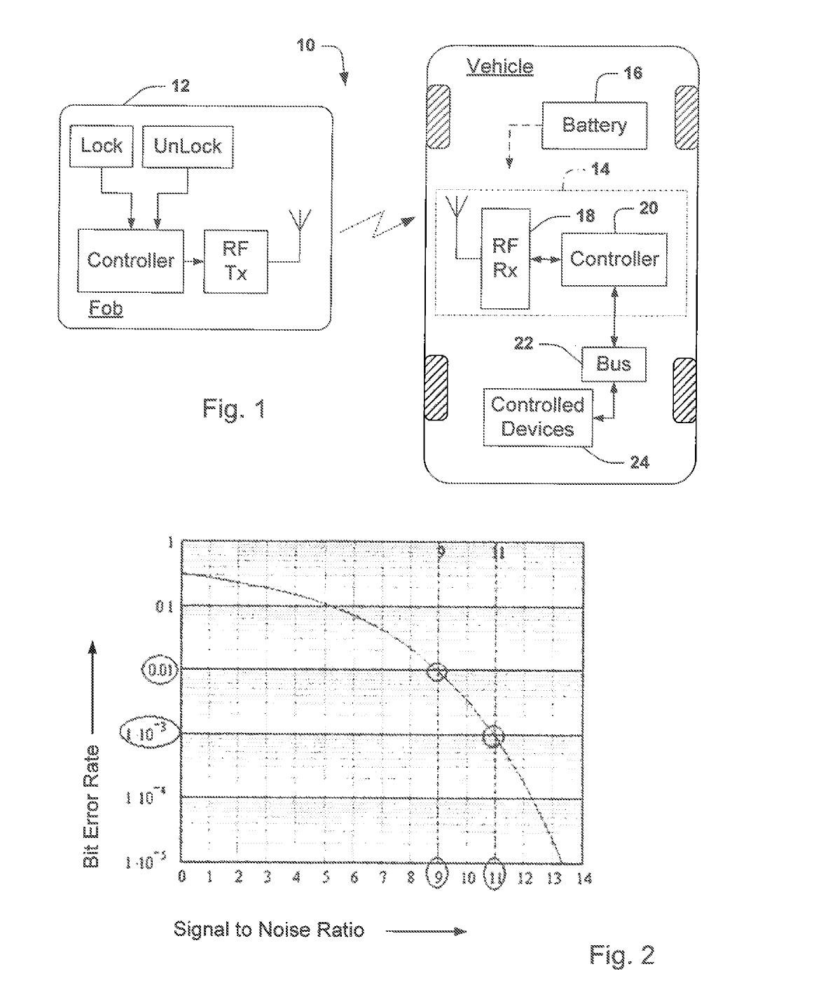

FIG. 2 illustrates in graphical form the sensitivity profile of a receiver. In the figure, the relationship between bit error and SIN ratio is shown for a receiver receiving a non-coherent FSK signal. As shown in the graph of FIG. 2:
To meet a 1% bit error criterion (1 bit error out of 100 bits, or 0.01), the required S/N ratio is 9 dB.
To meet a 0.1% bit error criterion (1 bit error out of 1000 bits, or 0.001), the required S/N ratio is 11 dB.
   One consequence of the illustrated graphical relationship is that a lower S/N ratio is required to receive a message having a smaller number of bits.

Although it takes longer to transmit a given message at a slow data rate than it does to transmit the same message at a faster data rate, the slow data rate provides better signal recognition at the receiver side. In turn, transmission at a fast data rate provides a better average factor with the attendant potential advantage of higher active transmitter power, while also allowing shorter receiver ON time and thus lower power consumption at the receiver. Moreover, use of a fast data rate could allow longer battery life for a transmitting device, since the fast data rate will permit the device to finish the transmission in a shorter time interval. These various, and competing, considerations affect power use both at the transmitter and at the associated polling receiver.

The inventor has discovered that the two portions of the transmitted signal, the wake-up portion and the data portion, have disparate S/N ratio requirements due to the difference in the number of bits that must be recognized in those respective portions. Far fewer bits are required for a valid wake-up than for a valid data message. Thus, the wake-up portion of the signal can tolerate a higher bit error rate than the data portion, which in turn means that a lower S/N ratio is permitted for the wake-up portion of the signal than for the data portion of the signal. This disparity is exploited in a system in accordance with the present invention to reduce signal transmission time by transmitting the wake-up portion of the transmitted signal at a faster bit rate than the data portion of the transmitted signal.

In accordance with one example embodiment of the present invention, fob 12 is configured to transmit the wake-up portion of the signal at a higher data rate than the data portion. Vehicle-based receiver 14 is correspondingly programmed to receive at a faster data rate for wake-up detection, at the outset of the ON time of the polling process, than for data detection. For the same number of wake-up bits, it will take less time for a receiver to process the fast bit rate data than the slow bit rate data. The receiver's polling ON time is thereby proportionately reduced and the receiver quiescent current draw is similarly lowered. Once vehicle-based receiver 14 is awake, it switches to the slow bit rate to decode the slow rate of the data signal.

The vehicle-based receiver 14 will be adapted, in any conventional manner, to have an adjustable data receiving rate. For example, receiver 18 may have adjustable data filters and/or phase locked loops that are set by controller 20 in accordance with the data rate requirements of the wake-up and data portions of the fob signal.

The present invention thus uses a fast bit rate for fast wake-up and realizes a consequent reduction in receiver ON time. From equation (1), above, the S/N ratio is degraded (lowered) when a faster bit rate is used in this manner. According to FIG. 2, the bit error rate is in turn worsened (increased) when the S/N ratio is lowered. This worsening of the bit error rate is tolerable for the wake-up portion of the transmitted signal, however, since the S/N of the wake-up portion would have otherwise been unnecessarily high. The present invention thus reduces the receiver searching ON time and current draw to the vehicle battery without sacrificing receiver sensitivity performance.

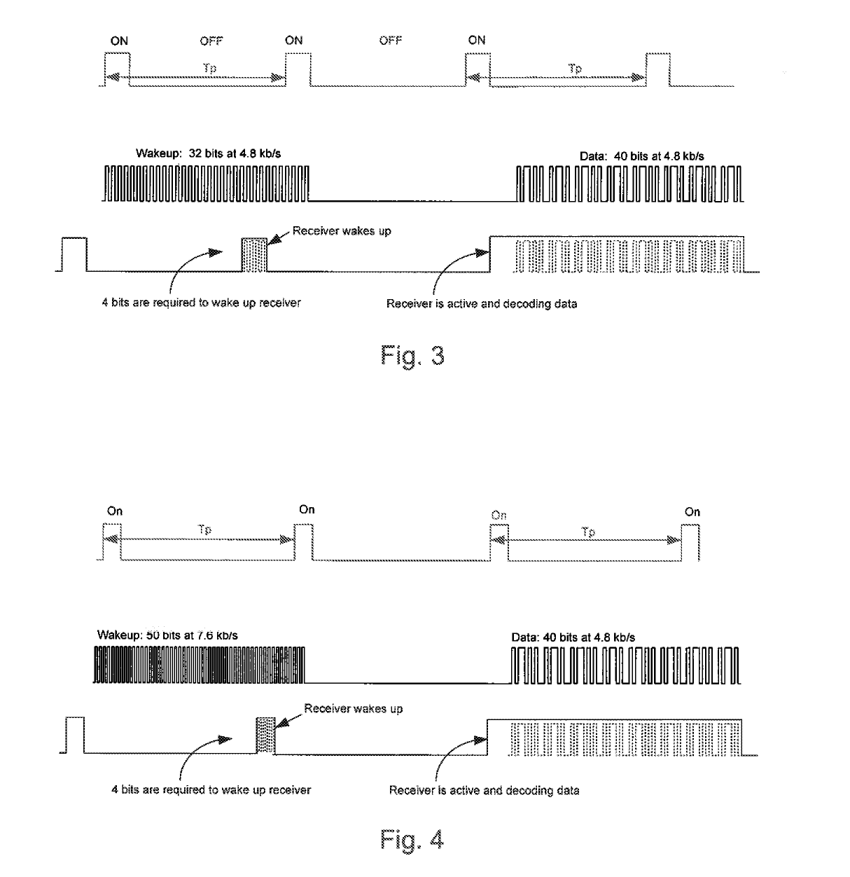

FIG. 3 shows three signal traces for a typical prior art RKE application, wherein the wake-up portion of the fob signal has the same bit rate as the data portion of the fob signal. The top trace of FIG. 3 illustrates the periodic polling process of the receiver, in the absence of a fob transmission, while the middle trace illustrates an example transmission from an RKE fob and the bottom trace illustrates the response of the vehicle-based receiver to the transmission. The wake-up portion and data portion both use the same bit rate of 4.8 kb/s (kilobits per second), in this example. As represented in the middle trace of the diagram, the signal transmitted from the fob has a wake-up portion that is 32 bits in length and a data portion that is 40 bits in length.

The period of the polling cycle of the vehicle receiver (ON time plus OFF time) is typically set at the length of the wake-up string minus the required length of the ON time of the receiver, thereby assuring that the wake-up portion of the fob signal is present for at least one entire ON time of the receiver. Assuming that at least four bits are required for wake-up of the receiver, the receiver polling period will then be (32−4) bits in length, and the duty cycle will thus be:

Duty_cycle=4/(32−4)=14.3% (2)

If the receiver current draw is Iₚₑₐₖ=10 mA when ON and zero when OFF, then the receiver quiescent current averaged over the duty cycle will be:

I_{q}=(Iₚₑₐₖ)(Duty_cycle)=10mA*14.3%=1.43mA (3)

A reasonable bit rate error limit for data decoding is 1 in 1000. In other words, if an error may be tolerated in only one out of each 25 data packets, then (since each packet has 40 bits) there must be a bit error only once in 25*40 bits, or 1000 bits. Given the sensitivity profile illustrated in FIG. 2, it can be seen that an error rate of 1/1000^{th} (i.e. 1*10⁻³) can be achieved if the signal is received with an 11 dB signal-to-noise ratio.

The required bit rate error for wake-up, however, is only 1 in 100. In other words, if an error may be tolerated in only one out of each 25 data packets, then (since each wake-up packet has only 4 bits, thereby being only 1/10^{th} the size of the data packet) there must be a bit error only once in 25*4 bits, or 100 bits. From the sensitivity profile illustrated in FIG. 2, it can be seen that an error rate of 1/100^{th} (i.e. 1*10⁻²) can be achieved if the signal is received with a 9 dB signal-to-noise ratio. This provides 2 dB to spare for wake-up detection (9 dB) when compared to the data detection (11 dB). The spare 2 dB can be used to speed up the data rate for wake-up and thereby reduce the receiver ON time.

Taking the log of Eq. (1):

$$Eb / N 0 \_dB = 10 log ( \frac{Eb}{N 0} ) \\ Eb / N 0 \_dB = 10 log [ \frac{S}{N 0} ( \frac{1}{R} ) ] = 10 log ( \frac{S}{N 0} ) + 10 log ( \frac{1}{R} ) \qquad ( 4 )$$

For two different bit rates of R1 and R2:

$$\begin{matrix}Eb / N 0 \_dB \_R 1 = 10 log ( \frac{S}{N 0} ) + 10 log ( \frac{1}{R 1} ) & ( 5 ) \\ Eb / N 0 \_dB \_R 2 = 10 log ( \frac{S}{N 0} ) + 10 log ( \frac{1}{R 2} ) & ( 6 )\end{matrix}$$

Subtracting equations (6) from (5) yields:

$$\begin{matrix}Eb / N 0 \_dB \_R 1 - Eb / N 0 \_R 2 = 10 log ( \frac{1}{R 1} ) - 10 log ( \frac{1}{R 2} ) & ( 7 ) \\ R 2 / R 1 = {10}^{( Eb / N 0 \_ dB \_ R 1 - Eb / N 0 \_ dB \_ R 2 ) / 10} & ( 8 )\end{matrix}$$

If, then, there is 2 dB difference between the 4 bits wake-up and 40 bits of data detection, we can set:

Eb/N0_dB_{—}R1−Eb/N0_dB_{—}R2=2dB (9)

From this it follows that R2/R1=1.58 and consequently R2 is equal to 1.58*4.8 kb/s, or 7.6 kb/s. It takes the same amount of time to transmit 50 bits at a 7.6 kb/s rate as to transmit 32 bits at a 4.8 kb/s rate.

FIG. 4 illustrates three signal traces that are similar to those of FIG. 3, but for a fob and vehicle-based receiver employing the present invention. Again, the top trace illustrates the periodic polling process of the receiver in the absence of a fob transmission, the middle trace illustrates an example transmission from a fob, and the bottom trace illustrates the response of the receiver to that transmission. In this example embodiment, the fob signal format includes a wake-up string of 50 bits at 7.6 kb/s and a data string of, again, 40 bits at 4.8 kb/s. At a wake-up bit rate of 7.6 kb/s rather than 4.8 kb/s, since the receiver still requires only 4 bits to wake-up, the receiver polling ON time is much shorter than in prior systems while the OFF time is still about the same (slightly longer). Using the same computational process described above, we find that the average quiescent current draw is now 0.87 mA instead of the 1.43 mA experienced before. That is about a 39% reduction in quiescent current.

Thus, with the present invention:
Wake-up and data portions of the signal are transmitted at different bit rates. The wake-up portion is transmitted at a faster bit rate and the signal data portion is transmitted at a slower bit rate.
The faster bit rate of the wake-up portion allows the receiver polling ON time to be reduced, which thereby reduces the average current draw at the receiver.
The fast wake-up rate and slow data rate method could be also used to increase the transmitting device's battery life by reducing the duration of the wake-up portion of the transmitted signal. Such a reduction of transmitter power would collaterally reduce the benefit at the receiver, however, since the receiver OFF time would have to be shortened as well, thereby increasing average quiescent power usage at the receiver.

From the above description of the invention, those skilled in the art will perceive improvements, changes and modifications. Such improvements, changes and modifications within the skill of the art are intended to be covered by the appended claims.

Having described the invention, the following is claimed:

1. A vehicle based transmitter/receiver system comprising:
a transmitter unit including a transmitter and an associated transmitter controller, said transmitter controller controlling said transmitter to transmit a first signal portion at a first baud rate and second signal portion at a second baud rate where the first baud rate is faster than the second baud rate, the first signal portion including a wake-up portion; and
a receiver unit adapted to receive both said first signal portion at said first baud rate and said second signal portion at said second baud rate, said receiver unit periodically waking up to listen for said first signal portion and only staying awake to receive said second signal portion if a valid said wake-up portion is received.

2. A system as set forth in claim 1, wherein said transmitter controller causes said transmitter to transmit a first signal portion including said wake-up portion and a second signal portion including a data portion, wherein said wake-up portion is transmitted at a baud rate that is faster than the baud rate at which said data portion is transmitted.

3. A system as set forth in claim 2, wherein said transmitter controller causes said transmitter to transmit first and second signal portions such that said first signal portion has more bits than said second signal portion, and further wherein said receiver unit wakes up for an interval that is only a fraction of the duration of said first signal portion.

4. A system as set forth in claim 2, wherein said receiver unit includes a receiver and a receiver controller, and wherein said receiver controller configures said receiver to receive said first signal portion at said first baud rate and, if said wake-up portion of the received signal is valid, configures said receiver to receive said second signal portion at said second baud rate.

5. A system as set forth in claim 1, wherein said transmitter unit comprises a remote keyless entry fob.

6. A system as set forth in claim 5, wherein said receiving unit controls the state of vehicle door locks in accordance with information contained in said second signal portion.

7. A system as set forth in claim 1, wherein said transmitter unit comprises a tire pressure monitoring sensor.

8. A system as set forth in claim 1, wherein said first baud rate is on the order of half again as fast as said second baud rate.

9. A method for controlling a vehicle based transmitter/receiver system comprising the steps of:
transmitting, at one location, a first signal portion at a first baud rate and second signal portion at a second baud rate, where the first baud rate is faster than the second baud rate, the first signal portion including a wake-up portion; and,
receiving, at a second location, said first and second signal portions, said receiving step including the steps of sleeping to conserve energy, periodically waking up to listen for the wake-up portion of the signal transmitted from said one location, and staying awake to receive the second signal portion only if a valid wake-up portion is heard;
wherein said step of periodically waking up includes the step of selecting the duration of the awake interval to be relatively short in view of the fast rate of the first baud rate.

10. A method as set forth in claim 9,
wherein said transmitting step includes the steps of transmitting a first signal portion including said wake-up portion at a first baud rate and transmitting a second signal portion including a data portion at a second baud rate,
wherein said duration of said awake interval at said second location is a fraction of the duration of said wake-up portion, and
wherein said method further comprises the steps of selecting said second baud rate to allow reception of said data portion at said second location with relatively low error rate, and selecting said first baud rate to be higher than said second baud rate so as to allow reception of a fraction of said wake-up portion with an error rate comparable to said relatively low error rate.

11. A method as set forth in claim 10, wherein said step of selecting said first baud rate comprises the step of selecting said first baud rate to be on the order of one and a half times the rate of said second baud rate.

12. A method as set forth in claim 9, wherein said receiving step includes the steps of configuring said reception to receive at said first baud rate while listening for said wake-up portion during said periodic awake intervals, and configuring said reception to receive at said second baud rate when receiving said second signal portion.

13. A method as set forth in claim 9, wherein said transmitting step includes the step of including vehicle access commands in said second signal portion.

14. A method as set forth in claim 9, wherein said transmitting step includes the step of including tire pressure information in said second signal portion.

15. A radio frequency transmitter for communicating digital information to a land-based motor vehicle, said transmitter sending a wake-up portion followed by a data portion, where the baud rate of said wake-up portion is faster than the baud rate of said data portion.

16. A radio frequency transmitter as set forth in claim 15, wherein said baud rate of said wake-up portion is on the order of one and a half times faster than the baud rate of said data portion.
